(19) United States
(12) Patent Application Publication
(10) Pub. No.: US 2015/0074808 A1
(43) Pub. Date: Mar. 12, 2015

(54) Rootkit Detection in a Computer Network

(71) Applicant: Triumfant, Inc., Research Triangle Park, NC (US)

(72) Inventor: Mitchell N. QUINN, Raleigh, NC (US)

(21) Appl. No.: 14/451,725

(22) Filed: Aug. 5, 2014

Related U.S. Application Data
(60) Provisional application No. 61/874,433, filed on Sep. 6, 2013.

(51) Int. Cl. H04L 29/06

(52) U.S. Cl. CPC H04L 63/145
USPC 726/23

(57) ABSTRACT

Systems and methods are provided for detecting a rootkit by way of a call timing deviation anomaly in a computer. The rootkits may be embedded in the operating system (OS) kernel, an application or other system function. An object call duration baseline is established for durations of object calls (e.g., a system or application call) initiated by the computer, where each object call has an associated call-type and the timing baseline is established on an object call-type basis. Object call durations initiated by the computers are monitored. An object call duration anomaly is detected when the object call duration fails a call duration deviation measurement test, and an indication of the call duration anomaly is generated when detected.

### FIELD OF THE INVENTION

The present invention relates to systems and methods for rootkit detection and automated computer support.

### BACKGROUND OF THE INVENTION

Management of a computer network, even a relatively small one, can be a daunting task. A network manager or administrator is often responsible for ensuring that users' computers are operating properly in order to maximize productivity and minimize downtime. When a computer begins to function erratically, or ceases to function altogether, a user will often contact a system administrator for assistance. As explained in U.S. Pat. No. 7,593,936 (“the '936 patent”), there are significant labor costs associated with investigating, diagnosing, and resolving problems associated with individual computers on a computer network.

Further, as explained in U.S. Pat. No. 8,104,087 (“the '087 patent”), there may be any number of reasons why a given computer is not working properly, including missing or corrupted file(s) or registry key(s), “malware” (including viruses and the like), as well as user-error. Additional intrusions into a given system may include the installation of rootkits. A rootkit is a class of software that is used to “hide” certain objects from the user or administrator of a computer. Among the types of objects typically hidden are processes, programs, files, directories, and on Windows® computers, registry keys. A rootkit performs functions by filtering the results of operating system calls used to retrieve certain objects and removing any of the objects the rootkit wishes to hide from the call results before they are presented to a user, logging system, or otherwise returned as part of the call return. By virtue of a rootkit's stealth, they are often malicious.

Unfortunately, due to staff limitations, an information technology (IT) department of a typical organization often resorts to three common “brute force” methodologies, e.g., reinstalling backups, resetting applications and data to a baseline configuration, and/or complete computer re-imaging, whereby all software is re-installed anew, on the computer instead of finding a root cause of a problem. The foregoing “brute force” approaches to computer problem remediation, as those skilled in the art will appreciate, amount to blanket data replacement methodologies that are not responsive to fixing, e.g., a singular, specific problem on a given computer and, moreover, often results in many undesirable side effects for the computer user. For example, the user may experience loss of user customized settings, may have to work through a lengthy downtime period or may wind up losing user data.

In light of the often critical importance of maintaining user data and avoiding unnecessary downtime, there is a need to provide an additional approaches or diagnoses to computer problem remediation.

### SUMMARY OF THE INVENTION

Embodiments of the present invention provide systems and methods for detecting rootkits that may be embedded in the operating system (OS) kernel, an application or other system function. In one embodiment, a method is implemented for detecting a rootkit in a computer comprising establishing an object call duration baseline for durations of object calls (e.g., system or application process or function calls) initiated by the computer, where each object call has an associated call-type and the timing baseline is established on an object call-type basis. Object call durations initiated by the computer are monitored. An object call duration anomaly is detected when the object call duration fails an object call duration deviation measurement test, and an indication of the call duration anomaly is generated when detected.

The '936 patent describes a system and method by which an anomaly on a given computer can be detected by using an “adaptive reference model” that may be used to establish “normal” patterns in data stored on a plurality of computers in a given network of computers. The '087 patent describes a system and method to automatically correct data anomalies that differ from the norm. Anomalies that are particularly suited to be repaired include, but are not limited to, a missing file, missing data, or a missing portion of a file or of data, a missing registry key, a corrupted file or a corrupted registry key. Anomalies may also include unexpected files or data.

The present invention embodiments may leverage such a non-runtime or statically operated systems for anomaly detection as described in the '936 and '087 patents, and may include runtime operated systems for real-time anomaly detection as described in U.S. patent application Ser. No. 13/605,445, filed Sep. 6, 2012 (“the '445 application”). Such runtime analysis can be used to detect unwelcome processes and threads, dynamic-link libraries (DLLs), Input/Output (I/O) handlers, etc. The techniques described herein may act in a stand-alone mode to identify undesired rootkits on a computer in a computer network or may be employed in addition to the above-described runtime and non-runtime techniques.

These and other features of embodiments of the present invention and their attendant advantages will be more fully appreciated upon a reading for the following detailed description in conjunction with the associated drawings.

### BRIEF DESCRIPTION OF THE DRAWINGS

FIG. 1 illustrates an exemplary environment in which an embodiment of the present invention may operate.

FIG. 2 is a block diagram illustrating a single computing device for detecting rootkits in accordance with an embodiment of the present invention.

FIG. 3A is a flowchart illustrating a specific example process for rootkit detection in accordance with an embodiment of the present invention.

FIG. 3B is a flowchart illustrating a generalized example process for rootkit detection in accordance with an embodiment of the present invention.

### DETAILED DESCRIPTION

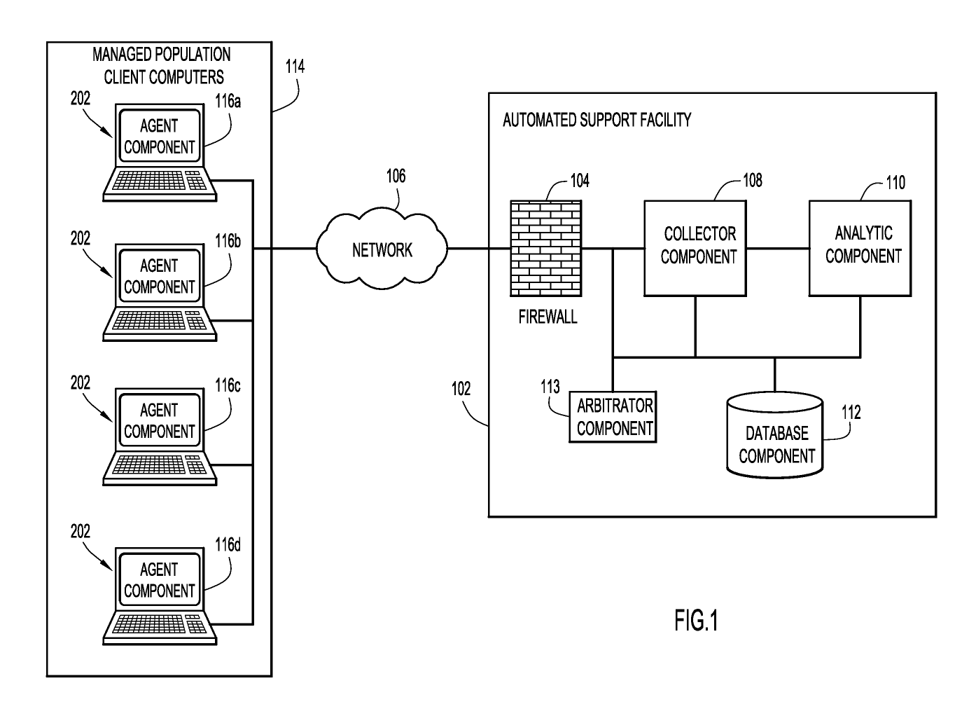

Embodiments of the present invention provide systems and methods for automated rootkit detection. Referring now to the drawings in which like numerals indicate like elements throughout the several figures, FIG. 1 is a block diagram illustrating an exemplary environment in which an embodiment of the present invention may operate. This environment and configuration is described in detail in the '956 application, with added details described in the '087 patent and '445 application, which are incorporated herein by reference in their entireties.

The environment shown in FIG. 1 includes an automated support facility 102 and a managed population of computers 114. Although the automated support facility 102 is shown as a single facility in FIG. 1, it may comprise multiple facilities or be incorporated into a site where a managed population of computers 114 or network of computers resides. The automated support facility 102 may include a firewall 104 that is in communication with a network 106 for providing security to data stored within the automated support facility 102. The automated support facility 102 may also include a Collector component 108. The Collector component 108 may provide, among other features, a mechanism for transferring data in and out of the automated support facility 102 using, e.g., a standard protocol such as file transfer protocol (FTP), hypertext transfer protocol (HTTP), or a proprietary protocol. The Collector component 108 may also provide processing logic necessary to download, decompress, parse incoming data, including “snapshots” of such data, and call timing monitoring data for detecting rootkits.

The automated support facility 102 may also include an Analytic component 110 in communication with the Collector component 108 and/or directly with network 106, and thus also the managed population of computers 114. The Analytic component 110 may include hardware and software for creating and operating on an “adaptive reference model” as described in detail in the '956 application, as well as a call timing monitoring process for detecting rootkits and may also include hardware and software for generating a call timing baseline.

Database component 112, which may be in communication with both Collector component 108 and Analytic component 110 may be used to store the adaptive reference model(s) and associated call duration timing data for detecting rootkits. The Analytic component 110 extracts adaptive reference models and snapshots from Database component 112, analyzes the snapshots in the context of the reference model, identifies and filters any anomalies. The Analytic component 110 may also analyze call durations to determine if a rootkit has been installed on a particular computer. The Analytic component 110 may also provide a user interface for the system.

FIG. 1 shows only one Collector component 108, one Analytic component 110 and one Database component 112. However, those skilled in the art will appreciate that other possible implementations may include many such components, networked together as appropriate.

As will be described in greater detail herein, embodiments of the present invention provide automated rootkit detection for the managed population 114 that may comprise a plurality of client computers 116a-d. Those skilled in the art will appreciate that the four client computers 116a-d shown are illustrative only, and that embodiments of the present invention may operate in the context of computer networks having hundreds, thousands or even more of client computers. The managed population 114 provides data to the automated support facility 102 via the network 106 using respective Agent components 202.

More specifically, an Agent component 202 is deployed within each monitored computer 116a-d and gathers data from its respective computer. Agent component 202 may perform Runtime Dependency Analysis or Static Dependency Analysis, as described in the '445 application. Furthermore, agent 202 performs system call duration monitoring according to the techniques described herein. For example, during an active scan before or during runtime or upon thread launch, the set containing all executable modules, as well as registry key and file access are monitored and their corresponding call durations are recorded. Any system call or application call that can be timed with a measurable reliability may be monitored, e.g., retrieving process lists, enumerating files in a particular directory, enumerating directories, registry key enumeration, etc. These various calls or object accesses may be referred to herein as object calls and their associated call start and stop times (durations) as call durations. The call durations for the various call types may be averaged (i.e., sum total of all call durations divided by the number of calls) to form the timing baseline for a given call type. After a sufficient number of calls have been performed, the calls can be monitored for changes in timing behavior. The timing baselines are established on each computer independently, in order to detect with high confidence even small deviations in timings from the baselines.

Additionally, Agent component 202 is preferably configured to transmit, e.g., over network 106 and thus potentially to all computers 116a-d, and may be configured to report timing anomalies or raw timing data to, e.g., collector component 108 for analysis by analytic component 110, and to database component 112 for storage.

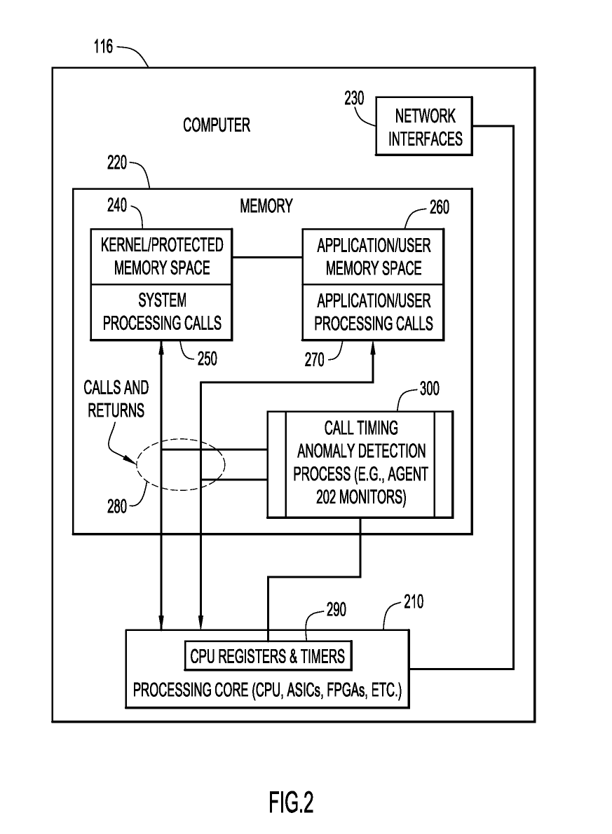

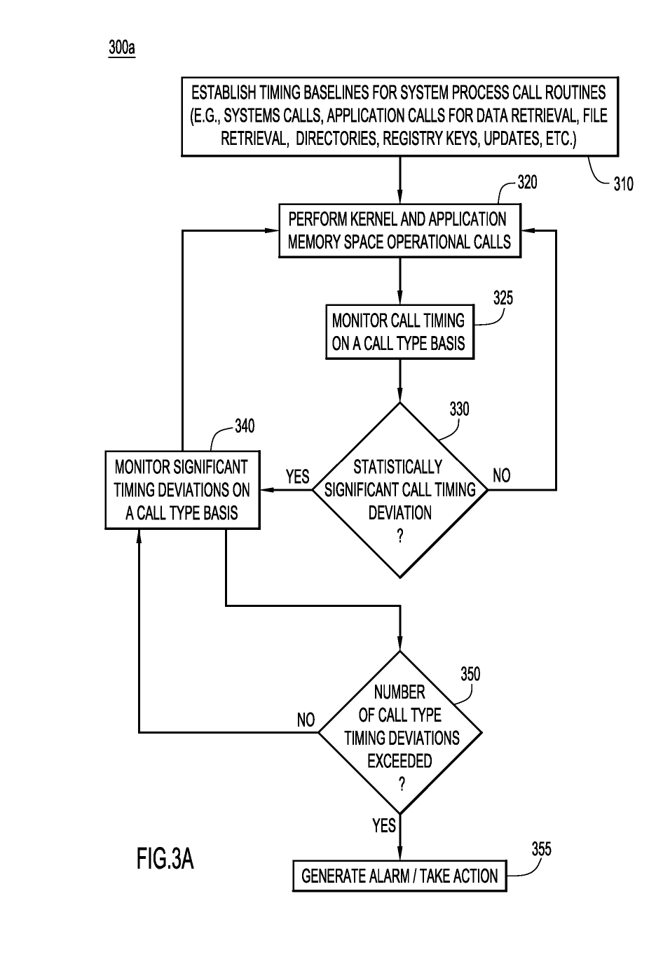

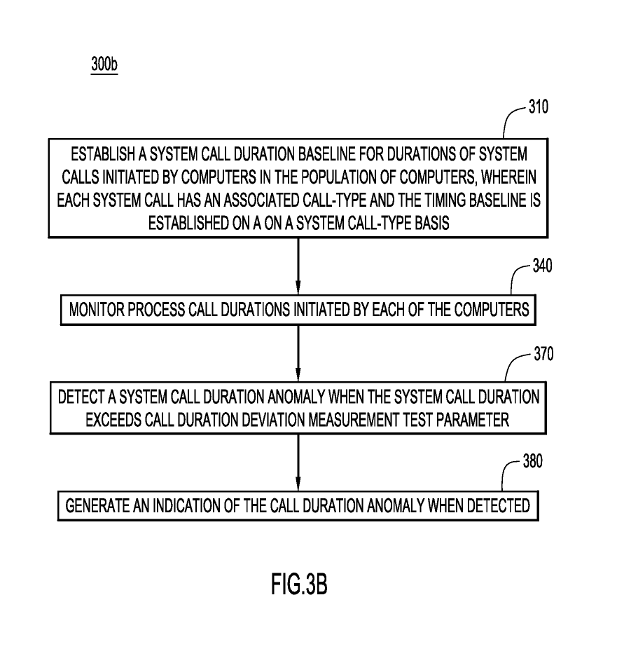

Each of the servers, computers and network components shown in FIG. 1 comprise processors and computer-readable media. As is well known to those skilled in the art, an embodiment of the present invention may be configured in numerous ways by combining multiple functions into a single computer or alternatively, by utilizing multiple computers to perform a single task. As shown in FIG. 2, a computer, e.g., computer 116a, is configured to perform call timing anomaly detection according to the techniques described herein. For ease of illustration, a call timing anomaly detection process 300 is outlined in connection with the description of FIG. 2. Process 300 is further described in connection with FIGS. 3A and 3B. It should be understood that that monitoring and anomaly detection functions of process 300 may be distributed among the various computers 116 and/or among components of automated support facility 102 shown in FIG. 1.

FIG. 2. depicts an example computer architecture (e.g., for one of computers 116) configured with a call timing anomaly detection process 300 for detecting rootkits according to the techniques described herein. Computer 116 includes a processing core or processor 210, one or more memories 220, and a one or more network interfaces 230. The processors utilized by embodiments of the present invention may include, for example, digital logic processors capable of processing input, executing algorithms, and generating output as necessary in support of processes according to the present invention. Such processors may include a microprocessor, an Application Specific Integrated Circuit (ASIC), Field Programmable Gate Arrays (FPGAs), state machines or any other fixed or programmable logic. Such processors include, or may be in communication with media, for example computer-readable media, which stores instructions that, when executed by the processor, cause the processor to perform the steps described herein.

Embodiments of computer-readable media include, but are not limited to, an electronic, optical, magnetic or other storage or transmission device capable of providing a processor, such as the processor in communication with a touch-sensitive input device, with computer-readable instructions. Other examples of suitable media include, but are not limited to, a FLASH memory, CD-ROM, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C#, C++, Visual Basic, Java and JavaScript.

The memories 220 may include a kernel or protected memory space 240, and an application or user available memory space 260. The division between kernel memory space 240 and user memory space 260 may be controlled by the host operating system (OS) or other memory control mechanisms, e.g., memory divided by hardware mechanisms. Kernel memory space 240 is used for typical OS functions such as for system calls and call processing 250 for the host, e.g., control for interfaces 230, disk access, user application control, etc. Application memory space 260 is used for user programs and applications, e.g., web browsers, word processing, email programs, etc. System object calls 250 and application object calls 270 are monitored by process 300 as collectively indicated at reference numeral 280 and are referred to herein as object calls.

The processing core 210 includes registers (e.g., Central Processing Unit (CPU) registers) and timers 290 that are typically found on most computing printed circuit boards (PCBs) or within the CPU itself. When object calls are made, they require some form of activity by the CPU. The CPU maintains a timing register that counts the number of CPU cycles or clock ticks. Note that this is a relative time that ultimately depends on the CPU's clock rate. The CPU clock rate can vary over time, e.g., the CPU clock is usually throttled back (slowed) to reduce power consumption or to reduce the thermal load (temperature) of the CPU chip. Accordingly, the absolute number of CPU cycles or clock ticks measures the amount of processing performed by the CPU regardless of actual clock rate. Thus, the number of CPU cycles indicates the work performed by the CPU for a given object call.

Briefly, per call type timing baselines indicate a normative or “normal” operation time for a particular function call, e.g., the initiation of a document retrieval or a system call to empty a network card buffer. Deviations from the norm have the potential to indicate that a rootkit has been installed, thereby, e.g., slowing down a call return due to the additional filtering or “hiding” that may be performed by a newly installed rootkit.

Once a timing baseline has been established, then timing deviations that may occur on any particular computer, e.g., one of computers 116a-d, can be monitored via process 300. In general, the time it takes to process any given call type varies even when the object call is exactly the same, over and over again. Timing variations occur due to the call start time (e.g., an inopportune time), when the processor is busy, or when certain resources have been temporarily locked (mutexed) by other processes. Furthermore, certain call types may have priorities assigned to them and lower priority processes may be preempted. Given such variations in call timing, deviations for a given object call type may be common. However, detecting when timing variations warrant the attention of a system administration function, i.e., determining when the deviations are beyond what is considered “normal” becomes slightly more complex. In other words, determining whether or not a rootkit has changed a given call object's call timing behavior may be based on whether call timing deviations are statistically significant.

FIG. 3A is a flowchart illustrating a specific example process for rootkit detection in accordance with an embodiment of the present invention. FIG. 3A depicts a specific example process 300a as a variation of process 300 described above. Another variation, 300b, is described in connection with FIG. 3B. At 310, timing baselines are established for system process call routines (e.g., object calls, call type timing, etc.). The baselines may be established well in advance of initiating object call monitoring or during initial operation of a particular computer before potential corruption may occur. At 320, kernel and application memory space calls are made in accordance with typical computer operations. At 325, object call timing is measured on a per call type basis. For example, object call timing for file access or retrieval, registry access, process enumeration, etc., are monitored based on their call type.

At 330, it is determined whether a statistically significant call timing deviation is present. In a brief example, call timing deviations may be compared to their average call type call duration. Any individual call duration may be denoted as T, the average baseline call time may be denoted as X̅, and the standard deviation of the baseline may be denoted as a. The mean and standard deviation described herein are with respect to the Gaussian or normal distribution (the bell curve), although other statistical distributions may be used, e.g., the Poisson distribution which is suited for event based modeling. In one example, a statistically significant call timing deviation may be considered significant when the time deviation varies by two standard deviations (i.e., 2σ). Thus, when T>( X̅+2σ), a significant timing deviation may be considered to have occurred, i.e., a rootkit may have been installed. While not likely, a rootkit installation may reduce object call time. Accordingly, in a second example if T<( X̅−2σ) or T>( X̅+2σ), then a significant deviation may have occurred. In a more generalized example, if T<(X−aσ) or T>( X̅+bσ), where a and b may be positive real numbers or integers, then a significant deviation may have occurred (i.e., a timing deviation measurement test failure has occurred). When a statistically significant deviation did not occur, as determined at step 330, process 300a returns to 320.

The above example describes a timing deviation test for a single call time measurement value. Given the statistical randomness that occurs in CPU call time clock cycles for any given call, a single measurement may not be enough to warrant detection of a rootkit and generate a rootkit detection notification or alarm. Thus, at 340, object call times that exceed the defined deviation, e.g., 2σ, are monitored. At 350, it is determined whether a consecutive (or windowed) number of call type timing deviations exceeds a threshold. When the number of consecutive deviations has been exceeded at 350, an alarm may be generated or added to a log file, and an action may be taken, at 355, e.g., a partial computer reimage or other remedy may be performed as described in the '936 and '087 patents, and the '445 application. For example, the defective process may be automatically replaced or repaired by automated support facility 102.

In one example, a threshold may be used, e.g., five deviations or test failures. When the number of consecutive system process call times that exceed the defined deviation exceeds five, process 300a proceeds to step 355. When the number of system call times that exceed the defined deviation do not exceed the defined threshold, process 300a proceeds to step 340 for additional monitoring. The above-described example provides a simplified framework for the additional statistical techniques described in connection with FIG. 3B.

FIG. 3B is a flowchart illustrating a generalized example process 300b for rootkit detection in accordance with embodiments of the present invention. At 310 and 340, timing baselines are established for system calls and monitored, e.g., as described above in connection with FIG. 3A. The call duration monitoring may be for a single computer or a computer in a population of computers. At 370, a system call duration anomaly is detected when the system (object) call duration exceeds call duration deviation measurement test parameter (duration or test statistic), i.e., the object call duration fails an object call deviation measurement test). At 380 an indication of the call duration anomaly is generated, e.g., an alarm may be generated that pops-up on a user display, an email may be sent, etc. In another example, the component indicated by the anomaly may be repaired (automatically) by automated support facility 102.

The call duration measurement test may be a simple threshold test as described above. However, a count of the number of times a threshold is exceeded, does not account for the test statistic over given time period. In other words, a time window or sliding window can account for the frequency of a given anomaly. For example, a threshold/window may be selected as 5/10 indicating that when at least 5 of the last 10 CPU object call cycles exceeds the test threshold or deviate from the test parameter, e.g., T>( X̅+2σ), then an alarm may be generated as described above. In other words, the test is limited to a rolling period of time and not merely an absolute count which could trigger an alarm without an anomaly being present, i.e., naturally occurring time duration deviations may trigger a false positive indication.

In addition, the sliding window may be used to adapt the baseline X̅ or the standard deviation σ, recognizing that it is possible for the baselines to vary over time. For example, after a given number object calls without an anomaly, the baselines or deviations may be updated. Moreover, certain parameters with respect to object calls may be included in the analysis. By way of example, when enumerating registry keys, if the object call enumerates a small number of keys (e.g., less that 100 keys), then the object call may be ignored for anomaly detection, but may otherwise be used to determine object call set up and tear down times. Accordingly, enumeration of more than 100 keys is monitored for anomalies. The object is to reduce noise and the occurrence of false positive anomaly detections. In this regard, object calls of short duration may be considered less likely to have a rootkit.

Timing deviations brought on by a rootkit installation may be identified using the statistical “t-test” (i.e., the Student's t-test) to estimate the likelihood that a detected anomaly is present. Essentially, a t-test assesses whether the means of two groups are statistically different from each other with a certain level of confidence by comparing the means of samples from the two groups, taking into consideration the variance of the samples. In this case, when a timing anomaly occurs, the t-test is used to compare the mean of one or more baseline timing metrics, e.g., X̅, to the mean of those timing metric(s) over a recent period of operation, e.g., denoted as Y̅, and identifies the timing anomaly as likely if the t-test suggests the mean test timing value is statistically different from the baseline. At a given point in time, such a test may fail to detect a timing anomaly or, conversely, falsely detect a timing anomaly when one does not in fact exist. The selection of a confidence level, which translates to a significant or “alpha” level within the t-test, controls the likelihood of a false detection of a timing anomaly.

The processes described above may be performed periodically or as part of the active scan process. In addition, at regular intervals, the agents 202 may send the timing statistics to the automated support facility 102. The automated support facility may use the information to update models and make determinations as the whether a rootkits is present on a given computer and take the appropriate remedial action.

As those skilled in the art will appreciate from the foregoing disclosure, by implementing automated systems and methods for rootkit detecting in a computer that is part of a population of networked computers within a managed network of computers, the systems and methods described herein may be embodied in other specific forms without departing from the spirit or essential characteristics thereof. The foregoing embodiments are therefore to be considered in all respects illustrative and not meant to be limiting.

What is claimed is:

1. A method for detecting a rootkit in a computer, comprising:
establishing an object call duration timing baseline for durations of object calls initiated by the computer, wherein each object call has an associated object call-type and the timing baseline is established on a on an object call-type basis;
monitoring object call durations initiated by the computer;
detecting an object call duration anomaly when the object call duration fails an object call duration deviation measurement test based on the associated object call-type and the timing baseline for a given object call-type; and
generating an indication of the object call duration anomaly when detected.

2. The method of claim 1, wherein the object call comprises one of an operating system call and an application call.

3. The method of claim 1, wherein the object call timing baseline comprises one or more statistical parameters and detecting an object call duration anomaly comprises detecting a statistically significant object call duration deviation.

4. The method of claim 1, wherein detecting the object call duration anomaly comprises detecting an object call duration that exceeds a threshold.

5. The method of claim 1, further comprising establishing a time window for the detection of an object call duration anomaly, and wherein detecting comprises determining when a duration of an object call exceeds a threshold for a number instances within the time window.

6. The method of claim 5, wherein the time window comprises a sliding time window, and wherein detecting comprises determining when a duration of an object call exceeds a threshold for a number instances within the sliding time window.

7. The method of claim 1, further comprising periodically adjusting the timing baseline.

8. The method of claim 1, wherein monitoring and detecting are performed by the computer or the computer that is part of a population of computers performing corresponding object calls or by a central monitoring station.

9. The method of claim 1, wherein monitoring comprises determining whether to monitor a given object call based on characteristics of the given object call.

10. An apparatus for detecting a rootkit in a computer t, comprising:
a network interface configured to facilitate communication over a network; and
a processor configured to:
establish object call duration timing baselines for durations of object calls, wherein each object call has an associated object call-type;
monitor object call durations;
detect an object call duration anomaly when an object call duration fails an object call duration deviation measurement test based on the associated call-type and the timing baseline for a given object call-type; and
generate an indication of the object call duration anomaly when detected.

11. The apparatus of claim 10, wherein the processor is configured to monitor object call durations comprising one of operating system call durations and application call durations.

12. The apparatus of claim 10, wherein the processor is configured to establish timing baselines comprising one or more statistical parameters and to detect an object call duration anomaly comprising a statistically significant timing deviation in object call duration.

13. The apparatus of claim 10, wherein the processor is configured to detect an object call duration anomaly when a given call duration exceeds a threshold.

14. The apparatus of claim 10, wherein the processor is further configured to establish a time window to detect an object call duration anomaly, and wherein the processor is configured to detect when a duration of an object call exceeds a threshold for a number instances within the time window.

15. The apparatus of claim 14, wherein the processor is configured to establish the time window comprising a sliding time window, and wherein the processor is configured to detect an object call duration anomaly when a duration of an object call exceeds a threshold for a number instances within the sliding time window.

16. The apparatus of claim 10, wherein the processor is further configured to periodically adjust the timing baseline and to determine whether to monitor a given object call based on characteristics of the given object call.

17. A system comprising the apparatus of claim 10, wherein:
the network interface is configured to receive information comprising object call durations for object calls initiated by one or more computers in a population of computers; and
the processor is further configured to:
establish object call duration timing baselines for durations of object calls initiated by computers in the population of computers;
monitoring object call durations initiated by each of the computers in the population of computers; and
detect an object call duration anomaly for a given computer when an object call duration from the given computer fails an object call duration deviation measurement test.

18. One or more computer readable storage media storing instructions for detecting a rootkit in a computer, the instructions, when executed by a processor, cause the processor to:
establish an object call duration timing baseline for durations of object calls initiated by the computer, wherein each object call has an associated object call-type and the timing baseline is established on a on an object call-type basis;
monitor object call durations initiated by the computer;
detect an object call duration anomaly when the object call duration fails an object call duration deviation measurement test based on the associated object call-type and the timing baseline for a given object call-type; and
generate an indication of the object call duration anomaly when detected.

19. The computer readable storage media of claim 18, wherein the instructions that are operable to monitor object call durations comprises comprise instructions that are operable to monitor one of an operating system call duration and an application call duration.

20. The computer readable storage media of claim 18, wherein the instructions that are operable to establish object call duration timing baseline comprise instructions that are operable to establish the object call duration timing baseline comprising one or more statistical parameters and the instructions that are operable to detect comprise instructions that are operable to detect a statistically significant object call duration deviation.

21. The computer readable storage media of claim 18, wherein the instructions that are operable to detect comprise instructions that are operable to detect an object call duration that exceeds a threshold.

22. The computer readable storage media of claim 18, further comprising instructions that are operable to establish a time window for the detection of an object call duration anomaly, and wherein the instructions that are operable to detect comprise instructions that are operable to determine when a duration of an object call exceeds a threshold for a number instances within the time window.

23. The computer readable storage media of claim 22, wherein instructions that are operable to establish the time window comprise instructions that are operable to establish a sliding time window, and wherein instructions that are operable to detect comprise instructions that are operable to determine when a duration of an object call exceeds a threshold for a number instances within the sliding time window.

24. The computer readable storage media of claim 18, further comprising instructions that are operable to periodically adjust the timing baseline.

25. The computer readable storage media of claim 18, wherein instructions that are operable to monitor comprise instructions that are operable to determine whether to monitor a given object call based on characteristics of the given object call.
